(19) United States
(12) Patent Application Publication
(10) Pub. No.: US 2008/0279307 A1
(43) Pub. Date: Nov. 13, 2008

(54) Very High Data Rate Communications System

(75) Inventors: Brian Gaffney, Bray (IE); Michael McLaughlin, Dublin (IE)

Correspondence Address: MICHAEL MCLAUGHLIN, 25 MEADOWFIELD, SANDYFORD, DUBLIN, D18, IE

(73) Assignee: DecaWave Limited, Dublin (IE)

(21) Appl. No.: 12/116,379

(22) Filed: May 7, 2008

Related U.S. Application Data
(60) Provisional application No. 60/916,469, filed on May 7, 2007.

(51) Int. Cl. H04L 27/36; H04L 27/38

(52) U.S. Cl. 375/298; 375/341

(57) ABSTRACT

A method of communicating data in which the data is transmitted using a star 8-Quadrature Amplitude Modulation scheme. In one embodiment of the invention, the data is encoded with a systematic trellis code in which the systematic bit corresponds to the amplitude of the transmitted signal. In another embodiment of the invention, the data is encoded using a Reed-Solomon coding without convolutional coding nor trellis coding.

### FIELD OF THE INVENTION

This invention relates to a very high data rate communications system, and in particular radio data communications systems. Data communication is understood to include speech, visual audio and other data as well as abstract data.

### BACKGROUND OF THE INVENTION

Very high data rate signals need to be transmitted at very high radio carrier frequencies, especially millimeter wavelengths. An example of such frequency bands is in the vicinity of 60 GHz, such as from 57 GHz to 66 GHz, which are now becoming available for new applications for unlicensed use. This allows consumer equipment to use this band. The bandwidth and power levels available allow wireless bit rates which are much higher than has previously been possible. The present invention is especially, but not exclusively applicable to these frequency ranges.

Transmissions of data at such carrier frequencies are susceptible to the effects of phase distortions and suitable coding schemes with robust error checking and correction are often needed. However, effective encoders and decoders tend to be expensive in terms of integrated circuit area, computing resource usage and electrical power consumption. The wider the bandwidth of the transmissions, the more complex the encoder and decoder tend to be. Using amplitude modulation, e.g. on-off keying, which can be decoded with an energy detecting non-coherent receiver reduces the complexity but pure amplitude modulation does not allow bits to transmitted by modulating the signal phase, which reduces performance by ignoring a whole modulation dimension.

It is known to use 8PSK (‘Phase Shift Keying’) or 16QAM (‘Quadrature Amplitude Modulation’) modulation schemes for data transmission. However both these modulation schemes are susceptible to phase distortion noise at very high radio frequencies. Prior art proposals of 8QAM modulation schemes have given lower bit rates per symbol without a corresponding improvement in bit error rates compared with 16QAM, for example.

### SUMMARY OF THE INVENTION

The present invention provides a method of communicating data, a transmitter and a receiver as described in the accompanying claims. Other aspects of the invention will be apparent from the following description of embodiments thereof.

### BRIEF DESCRIPTION OF THE DRAWINGS

FIG. 1 is a diagram showing proposed frequency bands becoming available for unlicensed,

FIGS. 2A and 2B are diagrams illustrating two convolutional codes used in embodiments of the present invention, given by way of example,

FIG. 3 is a diagram of an 8QAM constellation used in embodiments of the present invention, given by way of example,

FIG. 4 is a graph comparing performance of an embodiment of the present invention as illustrated in FIGS. 2A and 3 with a system using Gray code,

FIG. 5 is a graph showing performance of an embodiment of the present invention as illustrated in FIGS. 2A and 3 when operating in a base mode,

FIG. 6 is a illustrating coding features in an embodiment of the present invention as illustrated in FIGS. 2A and 3 when operating in a high data rate mode,

FIG. 7 is a graph showing performance of an embodiment of the present invention as illustrated in FIGS. 2A and 3 when operating in the high data rate mode of FIG. 6,

FIG. 8 is a schematic diagram of a receiver in accordance with an embodiment of the present invention operating under conditions of non-coherent reception,

FIG. 9 is a graph showing performance of an embodiment of the present invention as illustrated in FIGS. 2A and 3 when operating in the conditions of FIG. 6,

FIG. 10 is a diagram of a phased antenna array as used in an embodiment of the present invention,

FIG. 11 is a diagram of performance of a ternary spreading sequence as used in an embodiment of the present invention,

FIG. 12 is a chart illustrating a method of using the ternary spreading sequence of FIG. 11,

FIG. 13 is a table showing transmission parameters obtained in operation of an embodiment of the present invention when operating in different modes,

FIG. 14 is a table showing transmission parameters obtained in operation of another embodiment of the present invention when operating in different modes,

FIG. 15 is a chart summarising ranges of transmission obtained in operation of an embodiment of the present invention when operating in different modes,

FIG. 16 is a graph showing performance of an embodiment of the present invention as illustrated in FIGS. 2A and 3 when operating in base mode with a first channel model,

FIG. 17 is a graph showing performance of an embodiment of the present invention as illustrated in FIGS. 2A and 3 when operating in base mode with a second channel model,

FIG. 18 is a graph showing performance of an embodiment of the present invention as illustrated in FIGS. 2A and 3 when operating in base mode with a third channel model,

FIG. 19 is a graph showing performance of an embodiment of the present invention as illustrated in FIGS. 2A and 3 when operating in high data rate mode with the first channel model,

FIG. 20 is a chart summarising ranges of transmission obtained in operation of an embodiment of the present invention when operating in different modes,

FIG. 21 is a schematic diagram of a transmitter in accordance with an embodiment of the present invention, given by way of example,

FIG. 22 is a schematic diagram of a transmitter in accordance with an embodiment of the present invention, given by way of example,

FIG. 23 is a schematic diagram of a transmitter including an encoder in accordance with an embodiment of the present invention, given by way of example,

FIG. 24 is a schematic diagram of a transmitter including an encoder in accordance with another embodiment of the present invention, given by way of example, and

FIG. 25 is a schematic diagram of a transmitter including an encoder in accordance with yet another embodiment of the present invention, given by way of example,

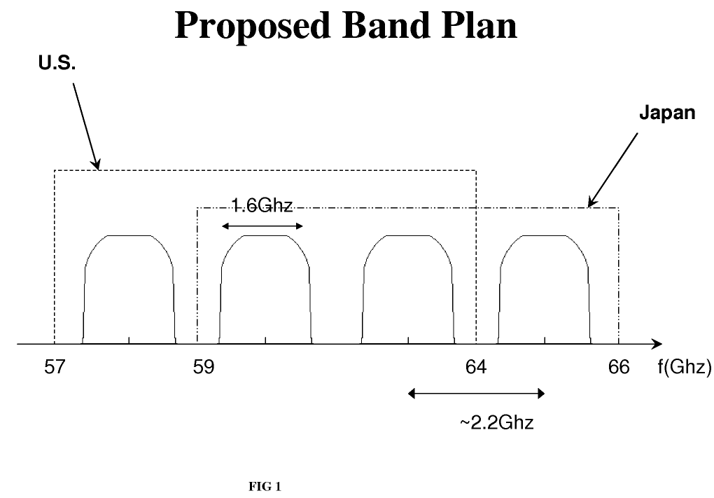

### DESCRIPTION OF EMBODIMENTS OF THE INVENTION

A method of communicating data in accordance with the embodiments of the present invention illustrated by the drawings uses:
Single Carrier system.
Adaptive Phased Antenna Array to boost SNR at receiver and provide spatial multiple access
Low complexity
Multi-national regulatory compliance

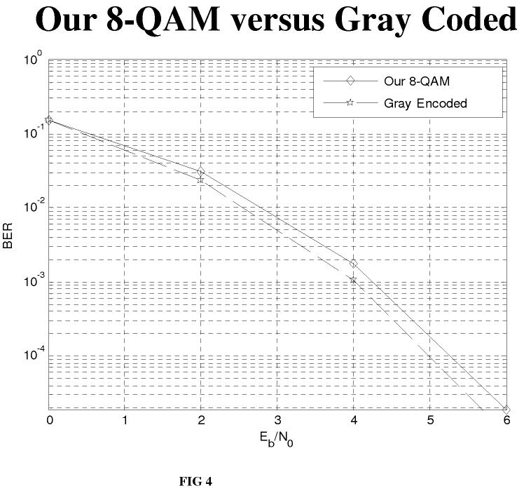

Modulation Scheme
8-QAM. Spectral efficiency of 3 bits/Hz can be obtained by using the constellation shown in FIG. 3, of the kind commonly referred to as star (or circular) 8-QAM. More specifically, with the constellation diagram of FIG. 3, the data is transmitted with a π/2 star 8-Quadrature Amplitude Modulation scheme which uses a two-level amplitude modulation combined with Quadrature Phase Shift Keying modulation to represent 3 bits per symbol. Phase noise causes the whole constellation in the receiver to rotate about the zero point. If the points of an 8PSK constellation rotate by more than 45 degrees, due to a combination of phase noise and other impairments, they are received at a position which is nearer to the neighboring point than to the ideal receive position. For the 8-star QAM constellation, the inner points would need to rotate by ninety degrees, and the outer points would need to rotate by approximately 60 degrees, to be mistaken for a neighboring point. The modulation is robust against the phase noise encountered at very high frequencies, such as 60 GHz. In other embodiments of the invention, geometrical inversion or rotation of both rings thereof together of the constellation diagram as shown in FIG. 3 are used. In this other embodiment, the rotation or inversion can be the same for every symbol, or can be different for each symbol but done on a prearranged schedule. An example schedule is a π/2 star 8-Quadrature Amplitude Modulation, where each symbol is rotated by π/2 radians more than the previous symbol was rotated.
Higher bandwidth efficiency than QPSK.
More resilient to phase noise and power amplifier problems than higher order constellations (16-QAM).
Allows for Non-Coherent reception
Only two levels which simplifies the transmitter

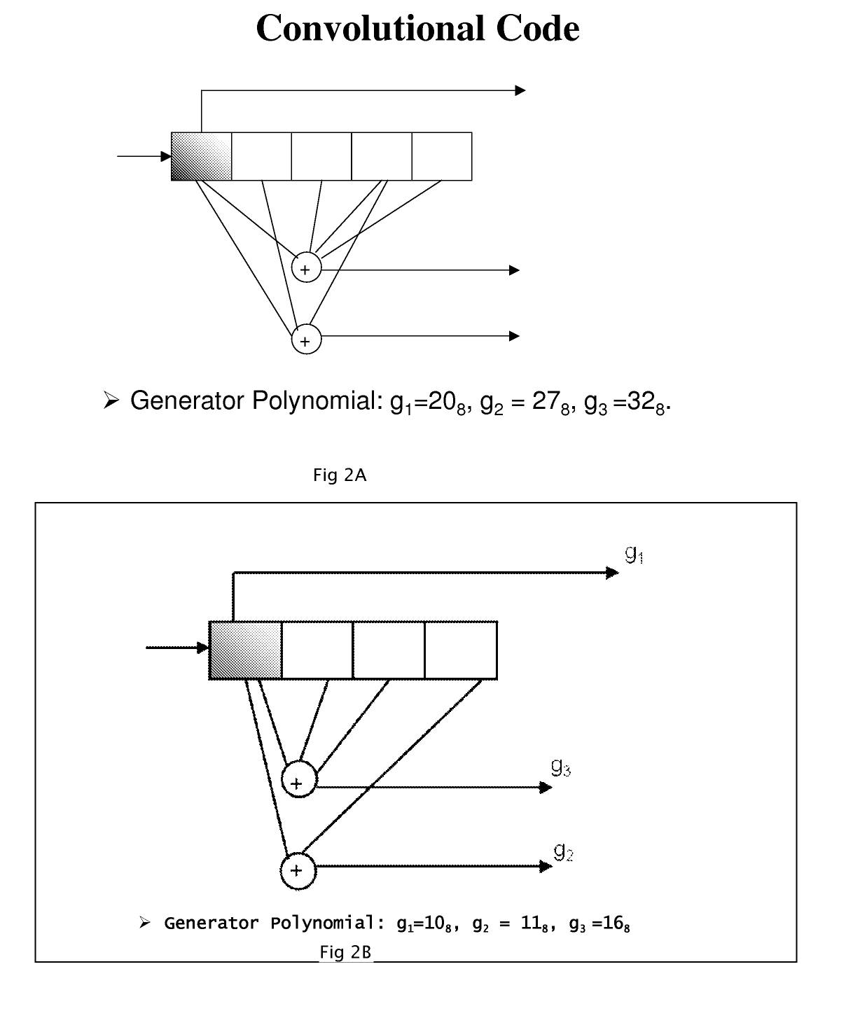

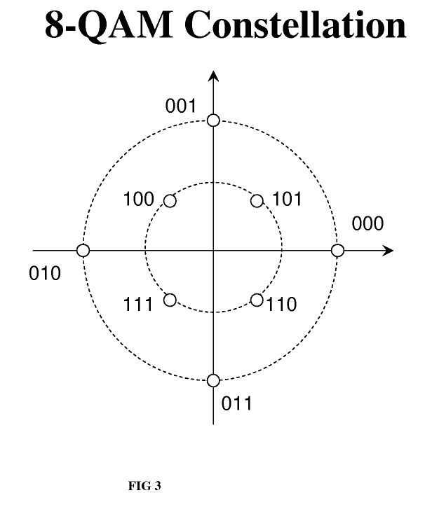

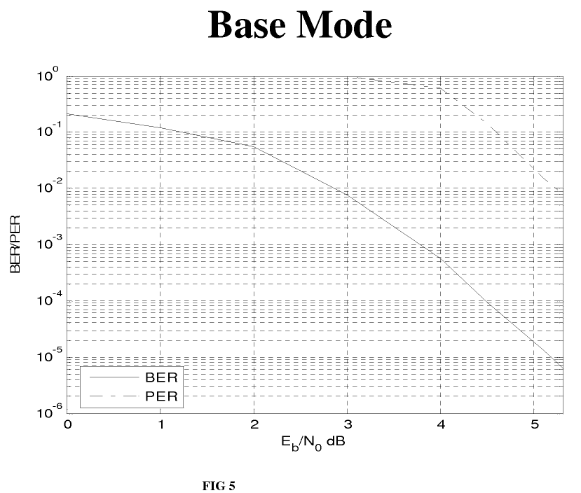

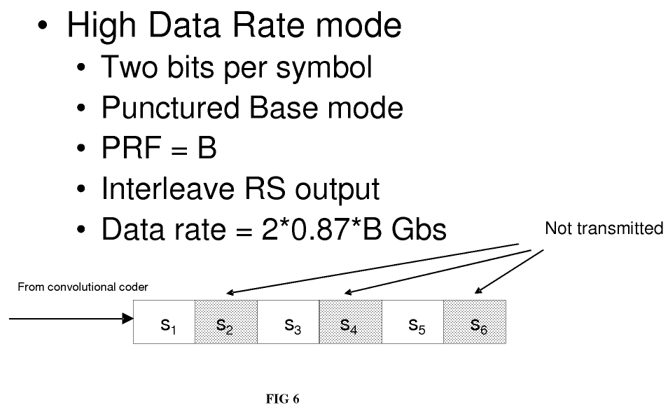

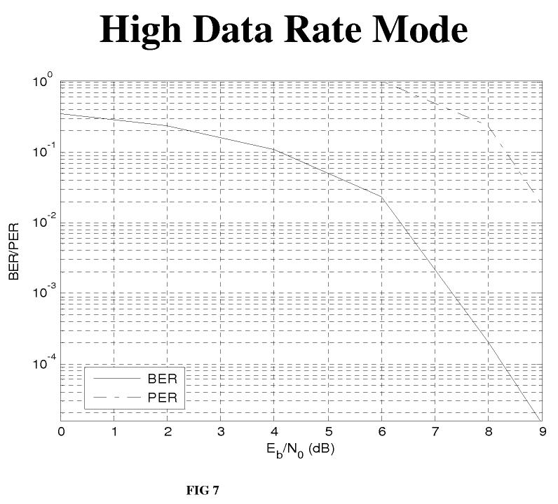

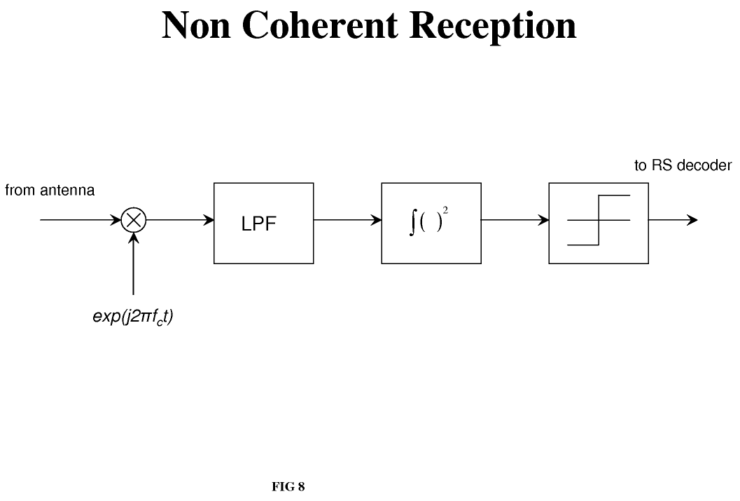

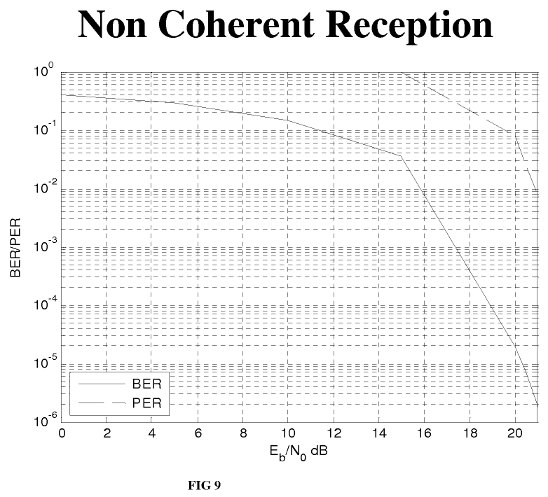

Bit to Symbol Mapping
The trellis code which comprises the convolutional code produced by the generator polynomial shown in FIG. 2 used in conjunction with a bit to symbol mapping of the kind shown in FIG. 3 results in a Viterbi decoder performance comparable with a conventional convolutional code of the same complexity, as shown in the comparison with a Gray code in FIG. 4.
The bit to symbol mapping shown in FIG. 3, in which the systematic bit corresponds to the amplitude of the transmitted signal, allows the systematic bit to be received non-coherently by means of energy detection.

Error Correction Coding
Outer systematic Reed Solomon block code.
Inner systematic convolutional code.
In one embodiment the code has a constraint length K=5
In another embodiment the code has constraint length K=4
The code is of rate ⅓.
In one embodiment one information bit in produces 3 bits out (the information bit and two parity bits) which are mapped to a symbol in the 8-QAM constellation.
Systematic to allow for Non-Coherent Reception for low complexity receivers
File Transfer and Kiosk usage scenarios

Outer Reed Solomon Code
In another embodiment the systematic Reed Solomon code is over the Galois field GF(2⁸) and is given as RS(255,239) where an input of 239 symbols creates 16 parity symbols for a rate 0.87 code
In another embodiment the systematic Reed Solomon code is over the Galois field GF(2⁶) and is given as RS(63,55) where an input of 55 symbols creates 8 parity symbols for a rate 0.94 code
Systematic gives the option of ignoring the parity symbols in low complexity receivers
Interleaved output before input to inner code improves performance by separating burst errors at the receiver

Systematic convolutional code. This presents the uncoded data as one of the coded bits. This has the advantage of allowing the receiver application to decide whether or not to use a Viterbi decoder. A standard systematic convolutional code has significantly poorer performance than a non-systematic code; however this embodiment of the invention gives a greatly improved performance compared to a standard code, with almost as good performance as a non-systematic code.

Systematic code gives the option of ignoring the parity bits. In this embodiment of the present invention, the code is used with a bit to symbol mapping which offers high performance compared with a Gray coded constellation with maximum MSED non-systematic code, as shown in FIG. 4 of the drawings.

It might be expected that Gray code bit mapping would produce the biggest minimum squared euclidean distance (MSED) between paths, which is a measure of the quality of the code. However, we have found that with this type of constellation, the nearest to a Gray code constellation that can be obtained (‘Quasi-Gray code’) in which the trellis code is a rate one over three code and has a constraint length of 5 has a minimum squared euclidean distance less than 50 for a full code and less than 7 for a punctured code. The embodiments of the present invention, including the bit to symbol mapping shown in FIG. 3, enable MSED greater than these values. An example of a suitable generator polynomial for a constraint length of 5 is: g1=20₈, g2=13₈, g3=06₈ which enables MSED of 89.6 for a full code and 7.5 for a punctured code. Another example of a suitable generator polynomial for a constraint length of 5, shown in FIG. 2A of the drawings is: g1=20₈, g2=27₈, g3=32₈.

For a constraint length of 4, Quasi-Gray rate one over three code has a minimum squared euclidean distance less than 42 for a full code and less than 7 for a punctured code. Again, the embodiments of the present invention, including the bit to symbol mapping shown in FIG. 3, enable MSED greater than these values. An example of a suitable generator polynomial for a constraint length of 4 is: g1=10₈, g2=17₈, g3=14₈ which enables MSED of 74.6 for a full code and 5.8 for a punctured code. Another example of a suitable generator polynomial for a constraint length of 4, shown in FIG. 2B of the drawings is: g1=10₈, g2=11₈, g3=16₈ which enables MSED of 63.7 for a full code and 9.3 for a punctured code.

The method of communication of this embodiment of the invention is capable of functioning in any one of four Data Modes:
Base mode 1.4 Gbps
High data rate mode 2.8 Gbps
Very High data rate mode 4.2 Gbps
Low rate (67 Mbps) back channel mode obtained by sending a direct sequence code

Base mode
One bit per symbol.
Pulse Repetition Frequency (PRF)=Bandwidth (B)
Data rate=0.87*B Gbs
Inner and Outer coding
Interleave RS output
Spatial multiple access

High Data Rate mode
Two bits per symbol
Punctured Base mode
PRF=B
Interleave RS output
Data rate=2*0.87*B Gbs

Very High Data Rate mode
No convolutional code
Reed Solomon RS(63,55)
Interleave RS output
Data rate=3*0.87*B Gbs

Low data rate back channel mode.
Length 21 Ipatov ternary sequence.
For example: +00−++−0+0+−++++−−0−
Golay Merit Factor of 5.3
Gives the option of 67 Mbs (base mode) or 133 Mbs (high data mode) which is more resistant to errors

Non Coherent Reception
The Non Coherent receiver is ideal for File Transfer or the Kiosk modes
The systematic bit decides which “ring” the transmitted symbol is on. Therefore, by using a simple energy detector receiver we can decode the systematic bit from any base mode signal.
The Outer Reed Solomon code then gives some optional error correcting capabilities
Used with a directional antenna, we can achieve a data rate of 0.87*B Gbs at short range
Enables a very low cost implementation
Ideal for integration into media players, phones, cameras etc.

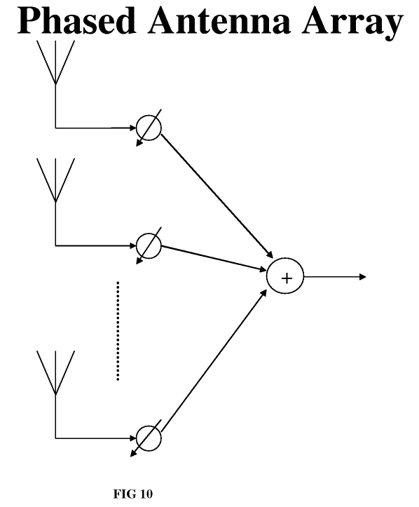

Phased Antenna Array
We propose using a phased antenna array as shown in FIG. 10 to boost the signal to noise ratio at the receiver input and provide spatial multiple access.
The phased antenna array can adapt to any direction of arrival (assuming omni directional elements)
The phased antenna array offers a low complexity solution
For omni directional antenna elements, the phased antenna array can achieve a high gain in any given direction. For example, ten elements (uniform linear array) can give a gain of 10 dBi
To achieve higher gains, directive elements need to be applied which require some physical alignment of Tx and Rx
The non-coherent mode could have a single highly directive element and assume the user will align the Tx and Rx

Hidden Node Problems
Major problem with directive antenna systems is finding Nodes.
To combat this problem, we propose using a single element mode.
For omni-directional antenna elements, we can now “see” in every direction.
For directive antenna elements, we can only “see” in the direction we can adapt in.
However, the path loss is so high at 60 Ghz, a very weak signal is received when we are not using the antenna array gain
The Solution:
Compensate for the lack of antenna array gain at Tx and Rx by spreading the signal to obtain an equal or higher processing gain
Much lower data rate, but not so important at the start of communication

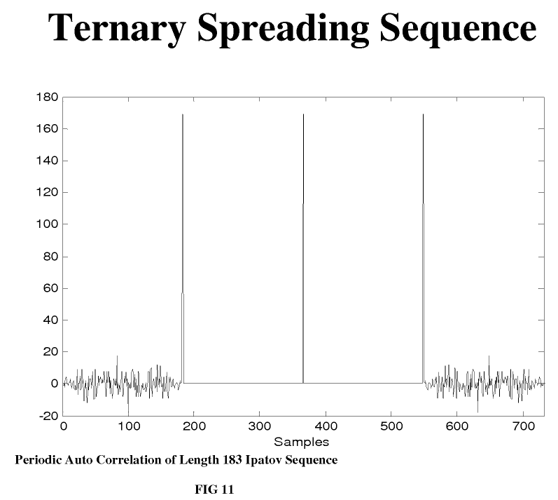

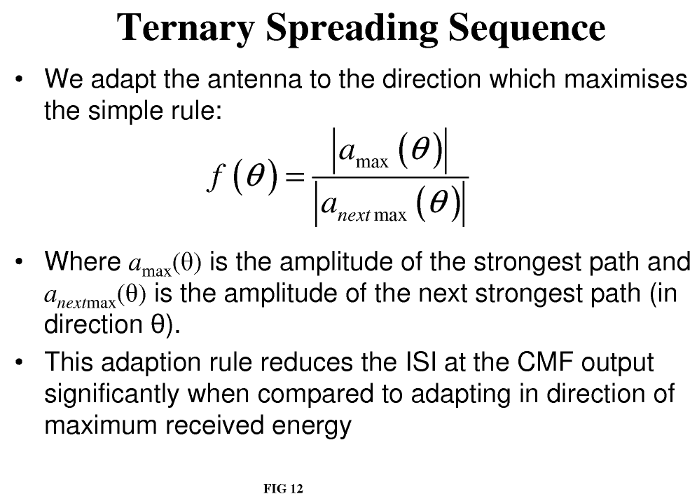

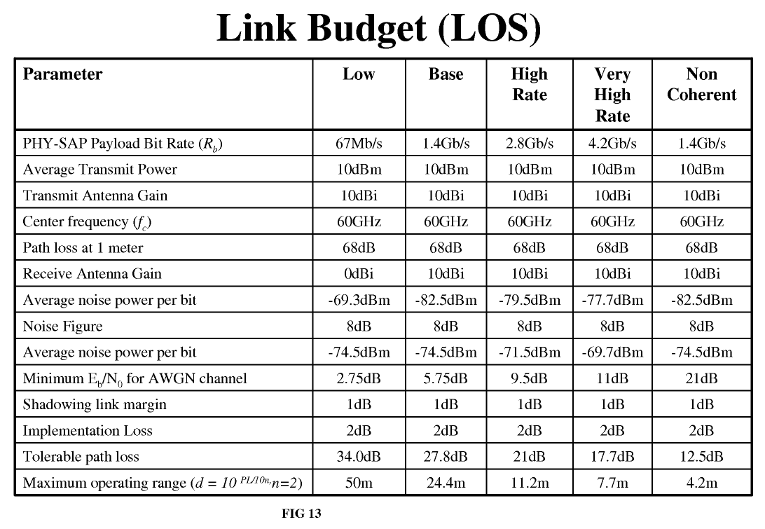

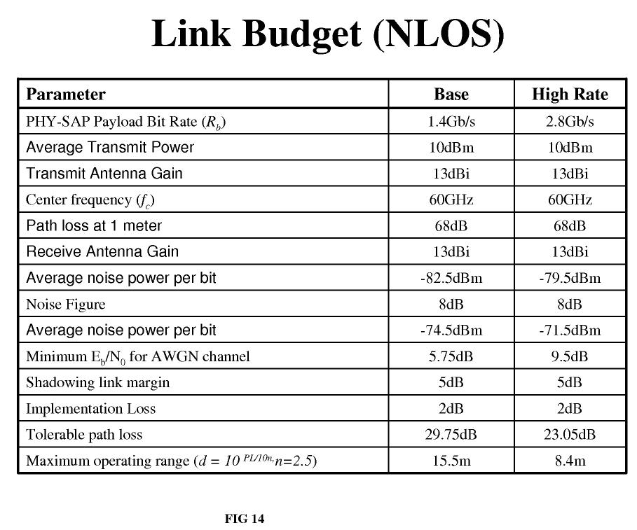

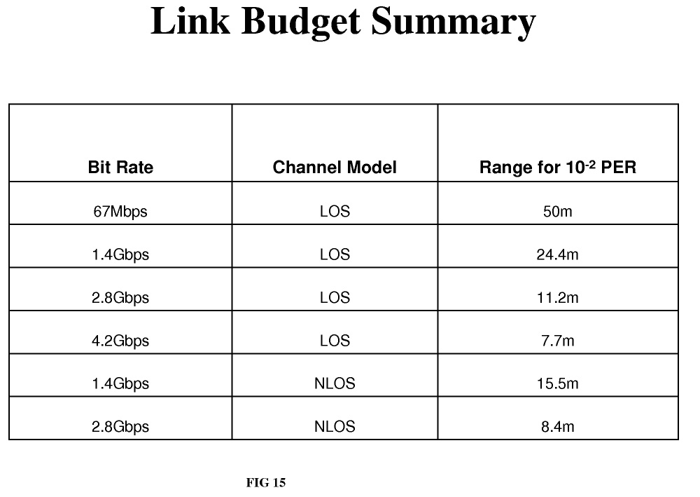

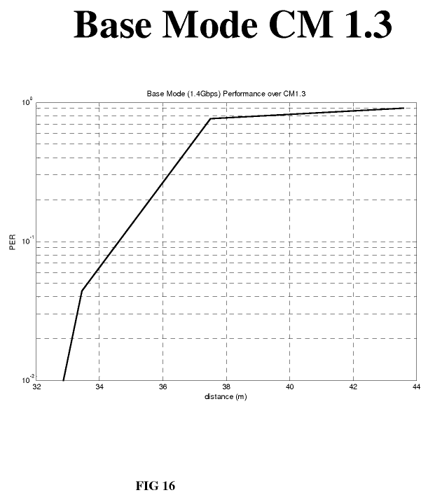

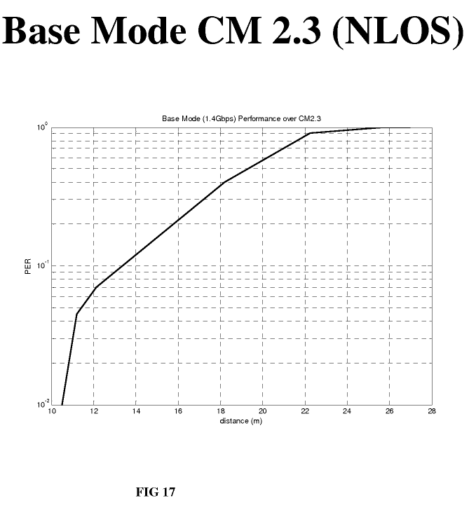

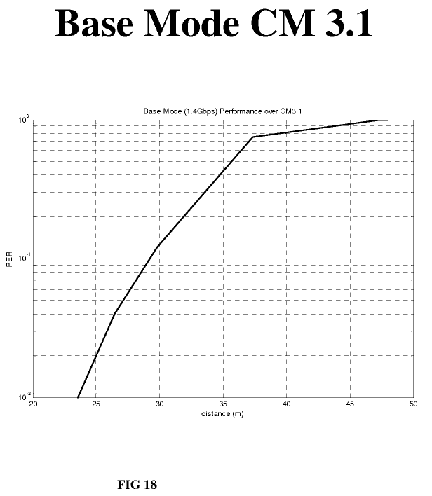

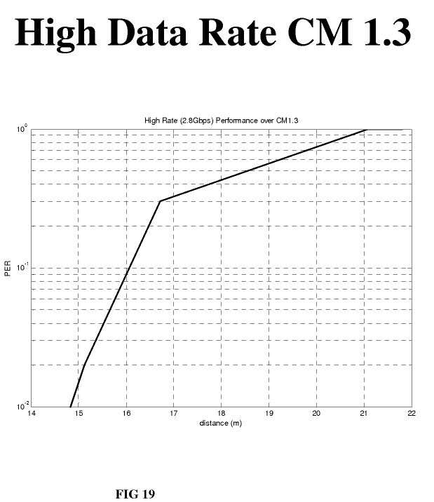

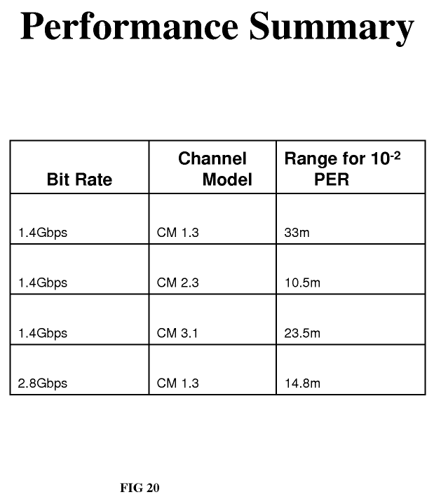

Ternary Spreading Sequence
Ipatov Sequence
Perfect Periodic Autocorrelation properties. See FIG. 11
Allows for accurate channel estimation for Channel Matched Filtering (CMF) and Antenna Array adaptation.
Used in 802.15.4a
For example, a length 183 sequence is equivalent to an antenna array gain of approximately 22.2 dBi
Many such sequences allows separate piconets to co-exist

### Example Length 183 Ipatov Sequence

+−−−+0+−−−−−++−−+++++++−−++0+−+−+−+−−00−−+−+−++−−++−−+−0−−−++−−0−++−0−−+++−+++−−+−+−−+−+++++0 −−++−−++−+−−−0+0+++0+−0−−−−−+−++−−0++++−+−−−−+++−+−+−−++−++−+0−++++−+−++++−++−+++++++−+−−+
With the perfect autocorrelation we can obtain an excellent estimate of the channel for the Channel Matched Filter (CMF)
Send multiple times, e.g. 16 times before each packet
However, inter symbol interference (ISI) due to multipath in the channels without a dominant single path is not combated by the CMF
Instead of equalization, we want to use the antenna to point in a direction which gives a useable channel
We adapt the antenna to the direction which maximises the simple rule shown in FIG. 12

### Summary of this Embodiment of the Invention

8-QAM modulation scheme
4 Data rates
Base mode of 1.4 Gps obtained with outer RS (rate 0.87) and inner convolutional (rate ⅓) coding
High data rate mode of 2.8 Gps obtained by puncturing base mode signal
Very high data rate mode of 4.2 Gps obtained by using only RS code
Lower rate for back channel using Direct Sequence code
Systematic code developed specifically for the 8-QAM constellation which enables a Non-coherent receiver architecture
Node discovery and channel adaptation with omni directional antenna mode with spreading gain from long ternary sequence

### Advantages of this Embodiment of the Invention

Low complexity solution
Constellation resilient to RF impairments
Simple Non-coherent mode
Ideal for low cost receiver e.g. for media player
Single carrier
Potential common signalling mode operation
More resistant to multipath
Ternary sequences and omni-directional antenna mode allow easy node discovery
Multi-national regulatory compliance

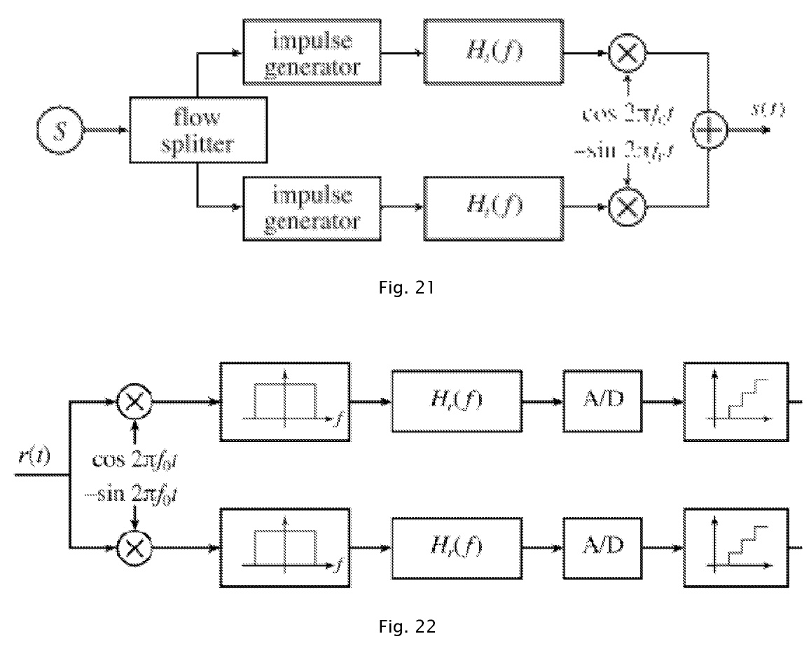

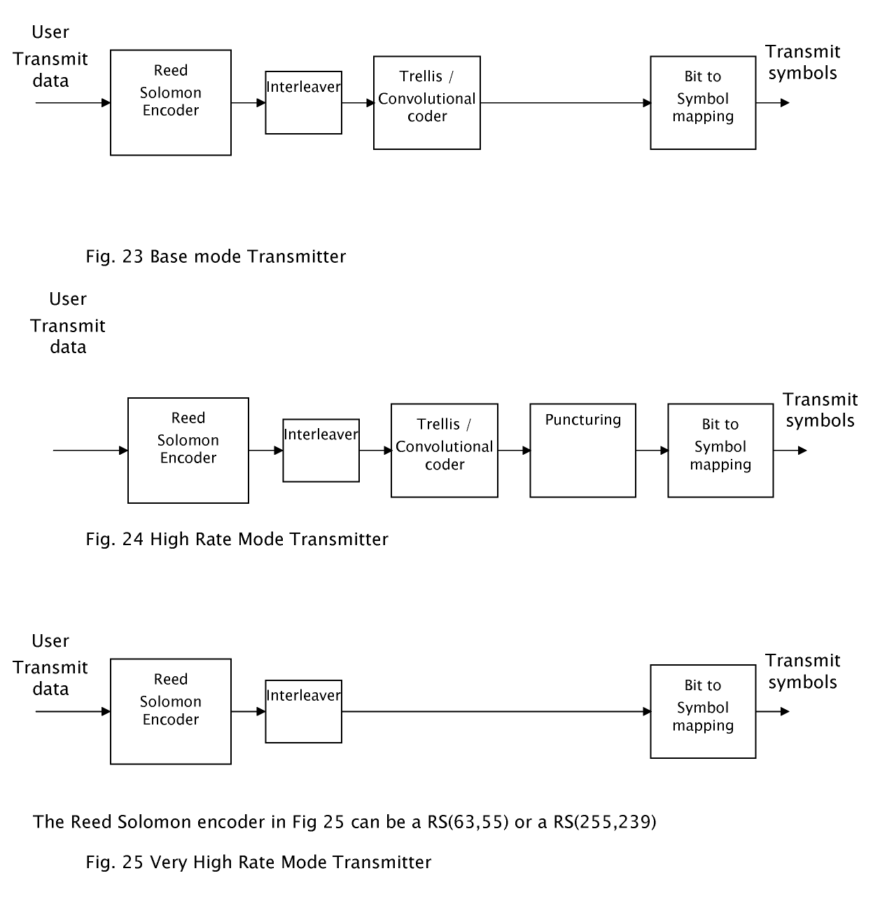

FIGS. 21 and 22 show schematic representations of respectively a transmitter for transmitting signals for communication by the method of this embodiment of the invention and a receiver for receiving signals for communication by the method of this embodiment of the invention.

In the transmitter of FIG. 21, first the flow of bits to be transmitted is split into two equal parts in a flow splitter, shaped in impulse generators; they are then encoded separately in an encoder by applying a transfer function Hₜ(f). Then the channel signals are modulated onto a carrier frequency f₀, with a phase difference of 90° between them. The two channel signals are then added to each other and transmitted over the radio channel.

The receiver performs the inverse process of the transmitter. The received radio signal is converted down to base band and separated into two channels by applying a phase shift of 90° between them. After low pass filtering, shown in the drawing with Hᵣ the receive filter's frequency response, the received analog signals are converted to digital, the channels are decoded separately by a respective decoders and the two flows of data are merged.

What is claimed is:

1. A method of communicating data in which the data is transmitted using a star 8-Quadrature Amplitude Modulation scheme, the data being encoded with a systematic trellis code in which the systematic bit corresponds to the amplitude of the transmitted signal.

2. A method of communicating data as claimed in claim 1, wherein the data is transmitted with a π/2 star 8-Quadrature Amplitude Modulation scheme which uses a two-level amplitude modulation combined with Quadrature Phase Shift Keying modulation to represent 3 bits per symbol.

3. A method of communicating data as claimed in claim 1, wherein the data is modulated in accordance with a constellation diagram as shown in FIG. 3, or a geometrical inversion or rotation of both rings thereof together.

4. A method of communicating data as claimed in claim 1, wherein the trellis code is a rate one over three code and has a constraint length of 5 and a minimum squared euclidean distance greater than 50 for a full code and/or greater than 7 for a punctured code.

5. A method of communicating data as claimed in claim 1, wherein the trellis code is a rate one over three code and has a constraint length of 5 and a generator polynomial g1=20₈, g2=13₈, g3=06₈ or g1=20₈, g2=27₈, g3=32₈, where g1 is the systematic bit and g2 and g3 are the other code bits.

6. A method of communicating data as claimed in claim 1, wherein the trellis code is a rate one over three code and has a constraint length of 4 and a minimum squared euclidean distance greater than 42 for a full code and/or greater than 7 for a punctured code.

7. A method of communicating data as claimed in claim 1, wherein the trellis code is a rate one over three code and has a constraint length of 4 and a generator polynomial g1=10₈, g2=17₈, g3=14₈ or g1=10₈, g2=11₈, g3=16₈ where g1 is the systematic bit and g2 and g3 are the other transmitted bits.

8. A method of communicating data as claimed in claim 1 wherein the trellis code is communicated with interleaved Reed-Solomon coding.

9. A method of communicating data as claimed in claim 1 wherein the trellis code is communicated with interleaved Reed-Solomon coding in punctured mode.

10. An encoder for encoding data for communication by a method as claimed in claim 1 arranged to encode the data using a star 8-Quadrature Amplitude Modulation scheme with a systematic trellis code in which the systematic bit corresponds to the amplitude of the transmitted signal.

11. A decoder for decoding data communicated by a method as claimed in claim 1 arranged to decode received data which has a star 8-Quadrature Amplitude Modulation scheme with a systematic trellis code in which the systematic bit corresponds to the amplitude of the transmitted signal.

12. A non-coherent receiver including a decoder according to claim 11 and arranged to detect the systematic code bit using energy detection.

13. A method of communicating data in which the data is transmitted using a star 8-Quadrature Amplitude Modulation scheme, the data being encoded using a Reed-Solomon coding without convolutional coding nor trellis coding.

14. An encoder for encoding data for communication by a method as claimed in claim 13 arranged to encode the data using a star 8-Quadrature Amplitude Modulation scheme with a Reed-Solomon coding without convolutional coding nor trellis coding.

15. A decoder for decoding data communicated by a method as claimed in claim 13 arranged to decode received data which has a star 8-Quadrature Amplitude Modulation scheme with a Reed-Solomon coding without convolutional coding nor trellis coding.
